(19) United States
(12) Patent Application Publication
(10) Pub. No.: US 2003/0213170 A1
(43) Pub. Date: Nov. 20, 2003

(54) Aerohydroponic Circulation

(76) Inventors: John Derek Snead, Decatur, GA (US); Samuel Jason Snead, Oxford, GA (US)

Correspondence Address: John D. Snead, 777 Hillmont Avenue, Decatur, GA, 30030, US

(21) Appl. No.: 10/249,633

(22) Filed: Apr. 25, 2003

Related U.S. Application Data
(60) Provisional application No. 60/375,367, filed on Apr. 25, 2002.

(51) Int. Cl. A01G 31/00; A01G 9/02

(52) U.S. Cl. 47/62 A; 47/65.5

(57) ABSTRACT

The process of Aerohydroponic Circulation is used for accelerated growing of a plant or plants while utilizing hydroponic gardening. It is also used for aiding in the recovery of a damaged or diseased plant or plants. This process provides the oxygen gas necessary for the plants roots to grow submerged continuously, in a hydroponic container, filled with nutrient solution to the base of the plant roots. This process effectively circulates the air and nutrient solution constantly.

### BRIEF DESCRIPTION OF DRAWINGS

The Process improves the growth and recovery of a plant or plants while there roots are submerged permanently into a container holding a nutrient solution. This is possible by constantly providing oxygen to the plants roots and constantly circulating the nutrient solution inside of a plant growth container while expelling the spent air out of the containers top. This process is explained in detail below with references to figures as follows:

FIG. 1 is a front elevation view of a plant in a hydroponic plant growing container. FIG. 2 is a front cut section view of FIG. 1 showing the process working. FIG. 3 is a top view of FIG. 1.

### DETAILED DESCRIPTION

The Invention of this process, does away with the need for an external reservoir, accelerates the growth of a plant or plants by constantly aerating and circulating the nutrient solution in a hydroponic container. This process allows the plant or plants roots to stay submerged permanently in the nutrient solution while staying healthy, and provides constant air circulation of the air space above the water level.

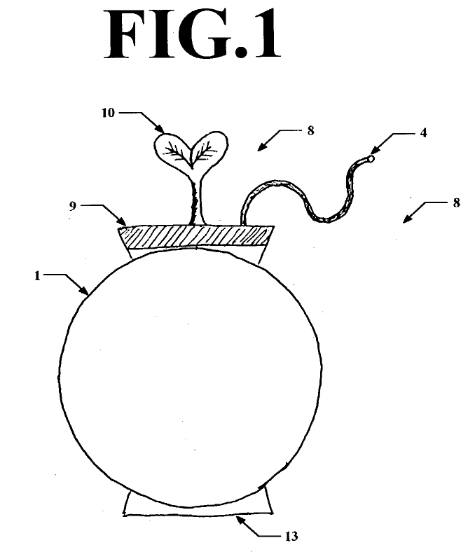

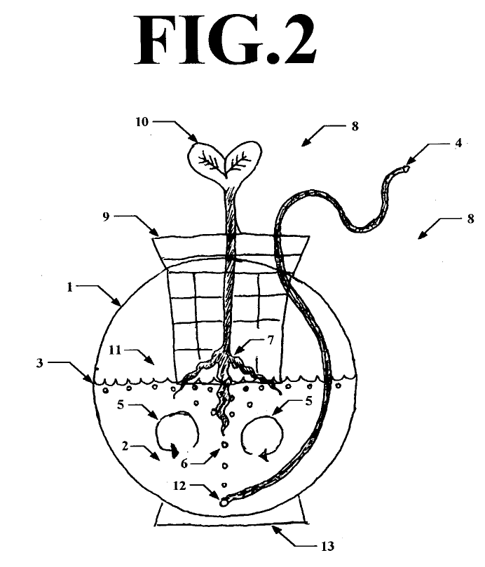

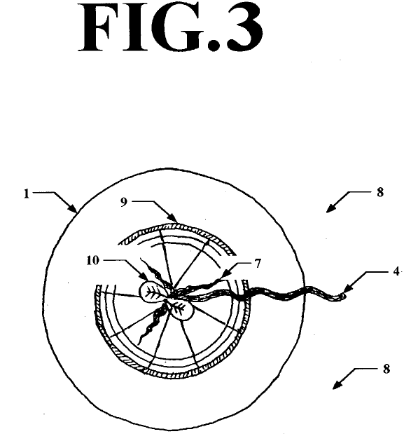

FIG. 1, FIG. 2 and FIG. 3 share the same numbering scheme for easier referencing.

They show a common hydroponic container 1, placed on a stand 13, used to hold the nutrient solution 2, and the air tube 4, used to carry the outside air 8, that is blown down through the tube 4, to the orifice 12, that releases air bubbles 6, into the nutrient solution 2. to create a directional current 5, which constantly circulates the nutrient solution 2, and upon reaching the top of the nutrient level 3, and the bottom of the plants holder 9, the air bubbles 6, feeds the roots 7; of the plant 10, then pops releasing into the exhausted air 11, to build pressure and vent the exhausted air 11, out of the hydroponic container 1. through the plant holder 10. exchanging back into the outside air 9.

We claim:

1. A new process of constantly blowing outside air, containing oxygen, through a tube into the bottom of a hydroponic container filled with nutrient solution enveloping the plant or plants roots and releasing the air through an orifice directly below the plant or plants roots to feed the oxygen to the plant or plants roots.

2. The process constantly circulates the nutrient solution to provide an even balance of nutrients to the plants roots for maximum availability.

3. The process constantly changes the air throughout the hydroponic container.

4. The process allows for the rate of air supplied to be increased and more orifices added supporting a plurality of plants, in hydroponic containers filled with nutrient solution.

5. The process forces the evacuation of the containers exhaust air through plant sites of the hydroponic container.

6. The releasing of the air, containing oxygen, from the orifices, rises through the nutrient solution making direct contact to the plant or plants roots.

7. This process provides the oxygen gas necessary for the plants roots to grow submerged continuously in a hydroponic container filled with nutrient solution.
